(19) United States
(12) Patent Application Publication
(10) Pub. No.: US 2012/0166859 A1
(43) Pub. Date: Jun. 28, 2012

(54) METHOD AND APPARATUS FOR GENERATING A SYSTEM CLOCK SIGNAL

(76) Inventors: Kenneth W. Fernald, Austin, TX (US); Thomas S. David, Austin, TX (US); Alan L. Westwick, Austin, TX (US)

(21) Appl. No.: 12/976,330

(22) Filed: Dec. 22, 2010

(51) Int. Cl. G06F 1/06

(52) U.S. Cl. 713/501

(57) ABSTRACT

An apparatus includes a processor, a clock recovery circuit and a frequency locked loop. The processor receives a system clock signal to clock operations of the processor; and the clock recovery circuit recovers a clock signal from data communication occurring over a bus. The frequency locked loop receives the clock signal from the clock recovery circuit as a reference clock signal, and the frequency locked loop is adapted to lock onto the clock signal provided by the clock recovery circuit to provide the system clock signal.

### BACKGROUND

The disclosure generally relates to a method and apparatus for generating a system clock signal.

Operations of a processor typically are synchronized, or clocked by, a periodic square wave signal, called a “clock signal.” The clock signal is generated by an oscillator, and the frequency of the clock signal typically is regulated by controlling the frequency of the oscillator. One way to control the oscillator's frequency is through the use of a resistor-capacitor (R-C) network, which may be part of the same integrated circuit as the oscillator. Another way to control the frequency is through the use of a crystal that is external to the integrated circuit that contains the oscillator.

### SUMMARY

In an exemplary embodiment, a technique includes recovering a first clock signal from data communication occurring over a bus and providing the first clock signal as a reference for a frequency locked loop. The technique includes operating the frequency locked loop to generate a second clock signal and furnish the second clock signal to a processor to clock operations of the processor.

In another exemplary embodiment, an apparatus includes a processor, a clock recovery circuit and a frequency locked loop. The processor receives a system clock signal to clock operations of the processor; and the clock recovery circuit recovers a clock signal from data communication that occurs over a bus. The frequency locked loop receives the clock signal from the clock recovery circuit as a reference clock signal, and the frequency locked loop is adapted to lock onto the clock signal provided by the clock recovery circuit to provide the system clock signal.

In yet another exemplary embodiment, a microcontroller includes an integrated circuit that includes a processor and a clock system to furnish a system clock signal to clock operations of the processor. The clock system includes a frequency locked loop and a clock recovery system that is adapted to recover a clock signal from data communication that occurs over a bus. The frequency locked loop locks onto the recovered clock signal to provide the system clock signal.

Advantages and other features of the invention will become apparent from the following drawing, description and claims.

### BRIEF DESCRIPTION OF THE DRAWING

FIG. 1 is a schematic diagram of a transceiver system according to an embodiment of the invention.

FIG. 2 is a schematic diagram of a microcontroller unit according to an embodiment of the invention.

FIG. 3 is a schematic diagram of a clock system of the microcontroller unit of FIG. 2 according to an embodiment of the invention.

FIG. 4 is a flow diagram depicting a technique to generate a system clock signal according to an embodiment of the invention.

FIGS. 5 and 6 are flow diagrams depicting techniques to control the system clock signal based on the operation of a radio according to embodiments of the invention.

FIG. 7 is a schematic diagram of a phase locked loop according to an embodiment of the invention.

FIG. 8 is a schematic diagram of a digital locked loop according to an embodiment of the invention.

FIG. 9 is a schematic diagram of a clock recovery circuit according to an embodiment of the invention.

### DETAILED DESCRIPTION

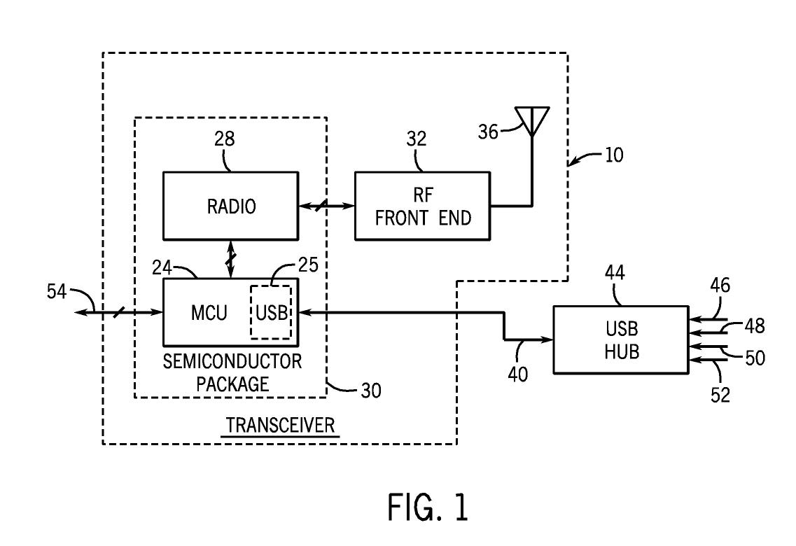

Referring to FIG. 1, in accordance with embodiments of the invention disclosed herein, a microcontroller unit (MCU) 24 may be used in a variety of applications, such as applications in which the MCU 24 controls various aspects of a transceiver 10 (as a non-limiting example). In this regard, the MCU 24, for this particular example, may be part of an integrated circuit (IC), or semiconductor package 30, which also includes a radio 28. As a non-limiting example, the MCU 24 and the radio 28 may collectively form a packet radio, which processes incoming and outgoing streams of packet data. To this end, the transceiver 10 may further include a radio frequency (RF) front end 32 and an antenna 36, which receives and transmits RF signals (frequency modulated (FM) signals, for example) that are modulated with the packet data.

As non-limiting examples, the transceiver 10 may be used in a variety of applications that involve communicating packet stream data over relatively low power RF links and as such, may be used in wireless point of sale devices, imaging devices, computer peripherals, cellular telephone devices, etc. As a specific non-limiting example, the transceiver 10 may be employed in a smart power meter which, through a low power RF link, communicates data indicative of power consumed by a particular load (a residential load, for example) to a network that is connected to a utility. In this manner, the transceiver 10 may transmit packet data indicative of power consumed by the load to mobile meter readers as well as to an RF-to-cellular bridge, for example. Besides transmitting data, the transceiver 10 may also receive data from the utility or meter reader for such purposes (as non-limiting examples) as inquiring as to the status of various power consuming devices or equipment; controlling functions of the smart power meter; communicating a message to a person associated with the monitored load, etc.

As depicted in FIG. 1, in addition to communicating with the radio 28, the MCU 24 may further communicate with other devices and in this regard may, as examples, communicate over communication lines 54 with a current monitoring and/or voltage monitoring device of the smart power meter as well as communicate with devices over a Universal Serial Bus (USB) 40. For example, various USB links 46, 48, 50 and 52 may communicate via a hub 44 and the USB 40 with the transceiver 10 for such purposes as communicating with a residential computer regarding power usage of various appliances, communicating with these appliances to determine their power usages, communicating with the appliances to regulate their power usages, etc. For purposes of communicating with the USB 40, the MCU 24 has an integrated USB interface 25, in accordance with some embodiments of the invention.

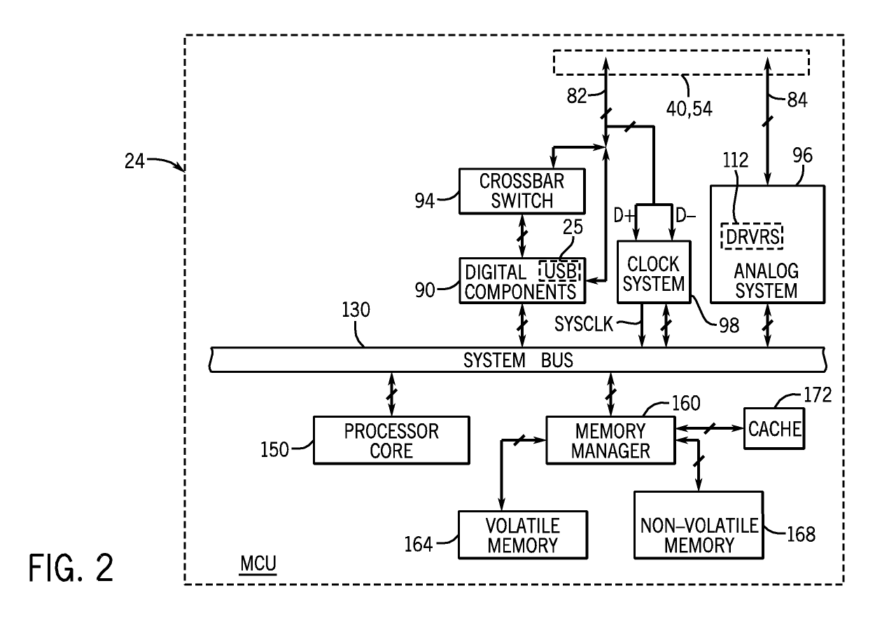

In accordance with embodiments of the invention, the MCU 24 is a “system on a chip,” which includes various components, such as the components that are depicted in FIG. 2, which may be fabricated on the same die. Referring to FIG. 2, among these components, the MCU 24 includes a processor core 150. As a non-limiting example, the processor core 150 may be a 32-bit core, such as the Advanced RISC Machine (ARM) processor core, which executes a Reduced Instruction Set Computer (RISC) instruction set. In general, the processor core 150 communicates with various other system components of the MCU 24, such as a memory controller, or manager 160, over a system bus 130. In general, the memory manager 160 controls access to various memory components of the MCU 24, such as a cache 172, a non-volatile memory 168 (a Flash memory, for example) and a volatile memory 164 (a static random access memory (SRAM), for example).

The MCU 24 also includes various digital peripheral components 90, such as (as non-limiting examples) the USB interface 25, a programmable counter/timer array (PCA), a universal asynchronous receiver/transmitter (UART), a system management bus (SMB) interface, a serial peripheral interface (SPI), etc. The MCU unit 24 may include a crossbar switch 94, which permits the programmable assigning of the digital peripheral components 90 to digital output terminals 82 of the MCU 24. In this regard, the MCU 24 may be selectively configured to selectively assign certain output terminals 82 to the digital peripheral components 90.

In accordance with embodiments of the invention, the MCU 24 also includes an analog system 96, which includes various interfaces to analog terminals 84 of the MCU 24. For example, the analog system 96 may include various components that receive analog signals, such as analog-to-digital converters (ADCs), comparators, etc. Moreover, the analog system 96 may include one or more low dropout (LDO) converters. As also depicted in FIG. 2, the MCU 24 includes current drivers 112, which may be generally controlled by software of the MCU 24.

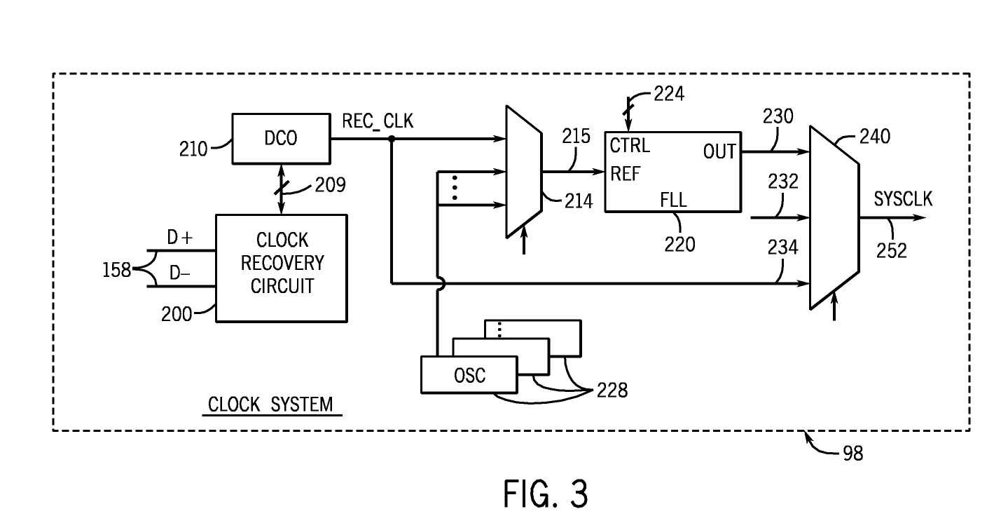

The MCU 24 also includes a clock system 98, which supplies one or more system clock signals (one of which is called “SYSCLK” in FIG. 2) to the system bus 130, which is used to clock operations, for example, of the processor core 150. Referring to FIG. 3, in accordance with some embodiments of the invention, the clock system 98 may be configured by the processor core 150 to select one of a number of different sources for the SYSCLK system clock signal, such as the clock signals that are generated by relatively low and high frequency oscillators 228 (crystal-based as well as RC-based oscillators, for example), as well as a clock signal (called the “REC_CLK” reference clock signal herein) that a clock recovery circuit 200 of the system 98 recovers from the bursty data communications that occur on the USB 40. In this manner, the clock recovery circuit 200 receives data signals (labeled as the “D+” and “D-” in FIG. 3) from the USB 40, and from these signals, the clock recovery circuit 200 extracts the relatively high accuracy (within one quarter percent of the nominal USB clock frequency) clock signal from the USB 40.

In addition to imparting the ability to select the clock sources that are set forth above, the clock system 98 also permits the REC_CLK reference clock signal to be used as a reference to a frequency locked loop (FLL) 220 for purposes of generating a SYSCLK system clock signal that has a frequency different from the frequency of the REC_CLK reference clock signal. In the context of this application, the language “frequency locked loop” means a circuit that locks onto the frequency and/or phase of a reference signal to produce a corresponding output signal whose frequency has a predefined relationship with respect to the frequency of the reference signal. In the clock system 98, the FLL 220 generates an output clock signal (provided at terminal 230), which has a frequency that is scaled by N/M, where “N” and “M” are, as non-limiting examples, both integers that are programmable (via terminals 224) by the processor core 150 or another component. Thus, depending on the values of N and M, the output clock frequency of the FLL 220 may be greater than, equal to or less than the frequency of the REC_CLK reference clock signal. In the context of this application, the term “reference clock signal,” unless otherwise specifically defined, refers to either an undivided reference signal or a divided reference signal. For example, the REC_CLK reference clock signal may be divided in frequency by a value, such as M, before used for comparison in the FLL220. Also, in the context of this application, unless otherwise specifically defined, the term “output clock signal” means an undivided output signal or a divided output signal. For example, the output clock signal may be divided by a value, such as N, before used for comparison in the FLL 220.

Referring back to FIG. 3, in addition to locking onto the frequency of the REC_CLK reference clock signal, the FLL 220 may further function as a phase locked loop (PLL), in which the FLL 220 establishes a controlled phase offset between the output clock signal and the REC_CLK reference clock signal. Although frequency locking may establish a fixed phase offset between the REC_CLK and output clock signals, the PLL mode of the FLL 220 permits the precise phase offset to be controlled. For example, in accordance with some embodiments of the invention, the FLL 220 establishes a substantially zero phase offset such that logic level transitions resulting in rising, or positive, edges of the REC_CLK reference clock signal are aligned in time with positive edges of the output clock signal. The FLL 220 may establish other predefined phase offsets, other than a zero phase offset, in accordance with other embodiments of the invention.

As depicted in FIG. 3, in accordance with some embodiments of the invention, the FLL 220 has a reference terminal 215 that, depending on the selection by a multiplexer 214, receives the REC_CLK reference clock signal or another reference clock signal, such as one of a number of clock signals that are provided by the oscillators 228, for example.

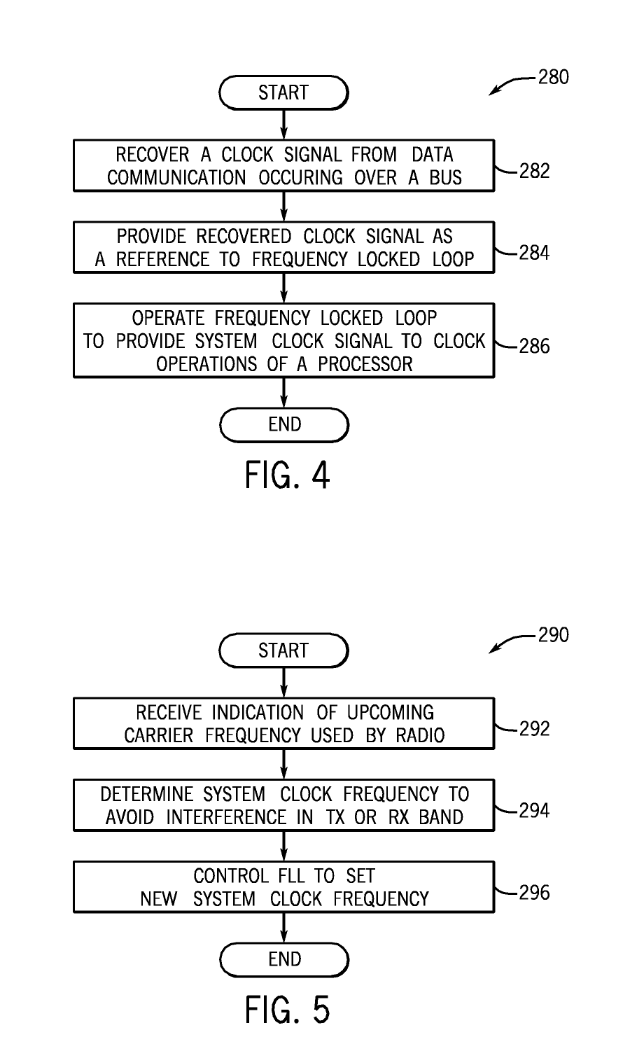

Thus, referring to FIG. 4, in accordance with embodiments of the invention, a technique 280 includes recovering (block 282) a clock signal from data communication that occurs over a bus, such as a clock signal that has a precision frequency (the clock signal used on the USB 40, for example). The recovered clock signal is provided as a reference clock signal to a frequency locked loop, pursuant to block 284; and the frequency locked loop is operated (block 286) to provide a system clock signal to clock operations of a processor. Due to the potential use of a relatively accurate clock signal, such as the recovered USB's clock signal, as the reference clock signal, the SYSCLK system clock signal is a relatively accurate clock signal as well.

In addition to allowing selectable reference clock signals for the FLL 220, the clock system 98 also permits the selection of other clock signals for the SYSCLK system clock signal. In this manner, as depicted in FIG. 3, the SYSCLK system clock signal is provided at an output terminal 252 of a multiplexer 240, which is controlled by the processor core 150, for example. In this regard, depending on the particular selection signals that are received by the multiplexer 240, the multiplexer 240 may select the output clock signal provided by the FLL 220 as well as the REC_CLK reference clock signal. Moreover, as depicted in FIG. 3, the multiplexer 240 may have additional input terminals, such as input terminal 232, which receive at least one additional input clock source signal, such as a signal produced by a crystal-based oscillator, for example.

Due to the flexibility imparted by the FLL 220, the processor core 150 (see FIG. 2) may from time to time control the frequency of the FLL 220 output clock signal (via the N and M parameters or the frequency of the selected reference clock signal) to adjust the system clock frequency. For example, the processor core 150 may adjust the system clock frequency based on the operation of the radio 28 (see FIG. 2). In this regard, the operations of the MCU 24, which are clocked by the system clock signal, may, if not for the features disclosed herein, introduce interference in the signal processing path of the radio 28. The location in the frequency domain of this interference is in part a function of the frequency of the system clock signal, and the impact of this interference depends on whether the radio's signal processing path can respond to the frequency content of the interference.

In accordance with embodiments of the invention disclosed herein, the MCU 24 adjusts the system clock frequency based on the frequency response (or band) of the radio 28. The radio 28 may not transmit in a fixed frequency band, however. In this manner, in accordance with some embodiments of the invention, the radio 28 communicates using spread spectrum-based communication, which employs frequency hopping. In other words, the radio 28 continually changes its reception and transmission frequency bands according to a frequency hopping schedule. When the radio's frequency band is about to change, the MCU 24 adjusts the system clock frequency accordingly to ensure that interference produced by the system clock signal does not appear, or at least appear in relatively low energy levels, in the current frequency band that is being used by the radio 28.

Referring to FIG. 5 in conjunction with FIGS. 2 and 3, in accordance with some embodiments of the invention, the processor core 150 performs a technique 290 to control the FLL 220 according to the operation of the radio 28. As non-limiting examples, the instructions that are executed by the processor core 150 to perform the technique 290 may be stored in the non-volatile memory 168 or may be stored in other memory, depending on the particular embodiment of the invention. According to the technique 290, the processor core 150 receives (block 292) an indication of an upcoming frequency band to be used by the radio 28, and for the following example, this upcoming band is different from the current frequency band that is being used by the radio 28.

As non-limiting examples, the indication that is received by the MCU 24 may be provided by the radio 28, by a radio controller in the MCU 24 or radio 28; or by a software routine being executed by the processor core 150. Based on this indication, the processor core 150 determines (block 294) a system clock frequency that substantially avoids interference in the radio's frequency band and controls (block 296) the FLL 220 to set the system clock frequency accordingly. For example, the processor core 150 may perform a write operation to write appropriate N and M values to registers of the FLL 220, for example, to change the target frequency for the SYSCLK system clock signal.

The MCU 24 may regulate the system clock signal frequency based on other MCU 24 or radio 28 operations. For example, in accordance with other embodiments of the invention, the MCU 24 may change (for example, lower or raise) the system clock signal frequency while the radio 28 is transmitting or receiving for purposes of reducing power consumption and/or potentially reducing interference with the radio's operations.

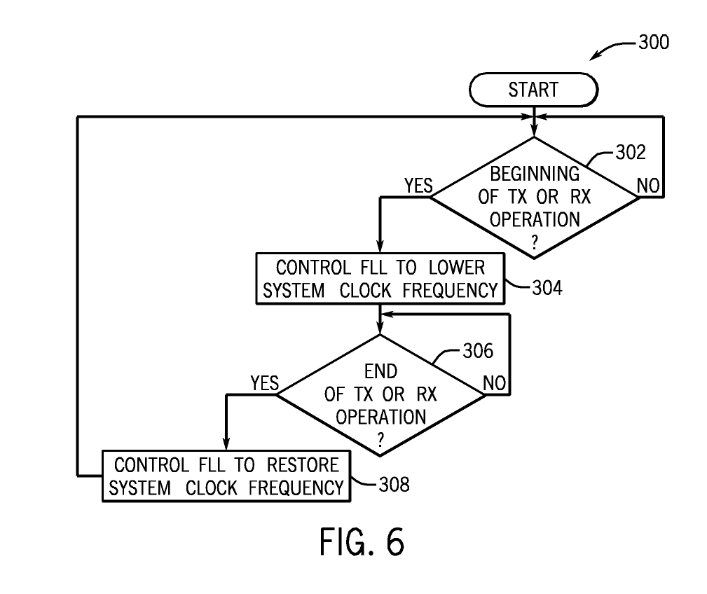

More specifically, referring to FIG. 6 in conjunction with FIGS. 2 and 3, in accordance with some embodiments of the invention, the processor core 150 may perform a technique 300. As a non-limiting example, the instructions that are executed by the processor core 150 to perform the technique 300 may be stored in the non-volatile memory 168 (see FIG. 2) or may be stored in another memory, depending on the particular embodiment of the invention. Pursuant to the technique 300, when the processor core 150 determines (diamond 302) that the radio 28 is about to begin a transmit or a receive operation, the processor core 150 controls the FLL 220 to lower the system clock frequency, pursuant to block 304. When the processor core 150 determines (diamond 306) that the transmit or receive operation has completed, the processor core 150 controls the FLL 220 to restore the system clock frequency to the previous higher frequency, pursuant to block 308. This higher system clock frequency may be beneficial, for example, for purposes of increasing processing speed (and thus, reducing processing time) to process packet data received by the radio 28.

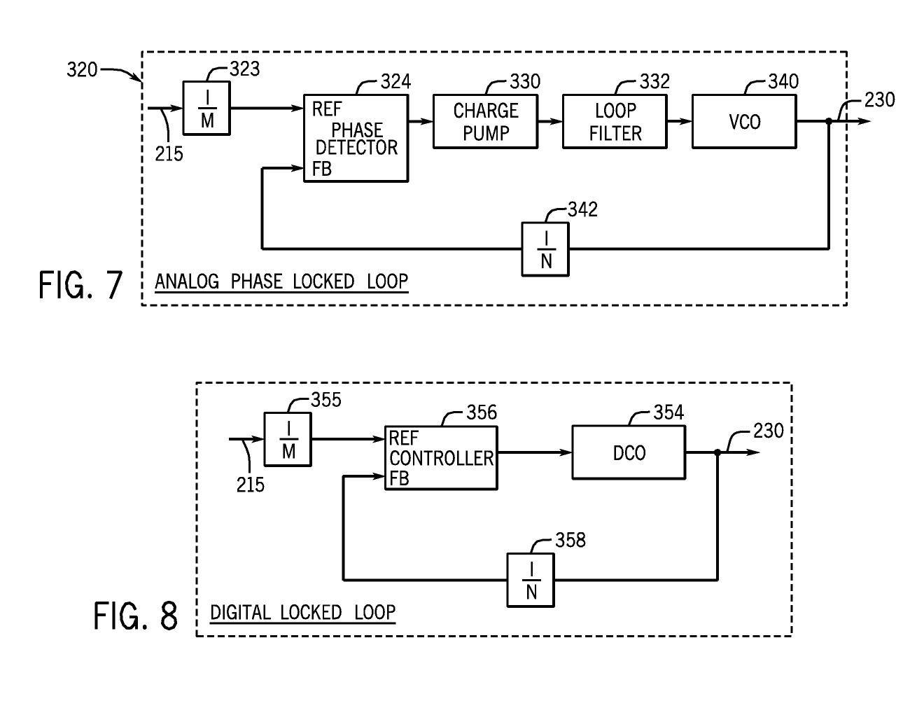

The FLL 220 may have one of numerous designs, depending on the particular embodiment of the invention. As a non-limiting example, the FLL 220 may be an analog phase locked loop (PLL) 320 that is depicted in FIG. 7. Referring to FIG. 7, the PLL 320 includes a voltage-controlled oscillator 340 that generates an output clock signal at the output terminal 230. The VCO's frequency is regulated to achieve locking through the use of a feedback loop, which controls the VCO 340 based on a comparison of the output clock signal with the reference clock signal that is received at the reference input terminal 215. More specifically, the PLL 300 includes a phase detector 324 that compares the phase of the output clock signal with the reference clock signal and controls a charge pump 330 accordingly. The signal that is produced by the charge pump 330 is filtered through a loop filter 332 to produce a control signal that regulates the frequency and/or phase of the VCO 340.

For the example that is depicted in FIG. 7, the phase detector 324 compares a frequency-divided version of the reference clock signal (provided by a 1/M frequency divider 323) with a frequency-divided version of the output clock signal (provided by a 1/N frequency divider 342), which means that the target frequency of the PLL 320 is N/M multiplied by the frequency of the reference clock signal that is received at the terminal 215. The N and M values are programmable by the processor core 150 to establish the corresponding target frequency ratio for the PLL 320.

FIG. 8 depicts a digital locked loop (DLL) 350, another non-limiting example, which may be used for the FLL 220, in accordance with other embodiments of the invention. The DLL 350 includes a digitally-controlled oscillator (DCO) 354 that generates the output clock signal. Similar to the PLL 320 (FIG. 7), the DLL 350 includes frequency dividers 355 and 358 to establish the selectable target frequency based on the N/M ratio. The DLL 350 includes a controller 356 that generates a control signal to control the frequency and/or phase of the DCO 354 based in part on a comparison of the output and reference clock signals. Exemplary implementations of the DLL 350 are discussed in U.S. patent application Ser. No. ______, entitled, “FREQUENCY LOCKED LOOP,” (attorney docket no. SIL.0149; D-10-600-27), which is filed concurrently herewith, assigned to the same assignee and is hereby incorporated by reference in its entirety.

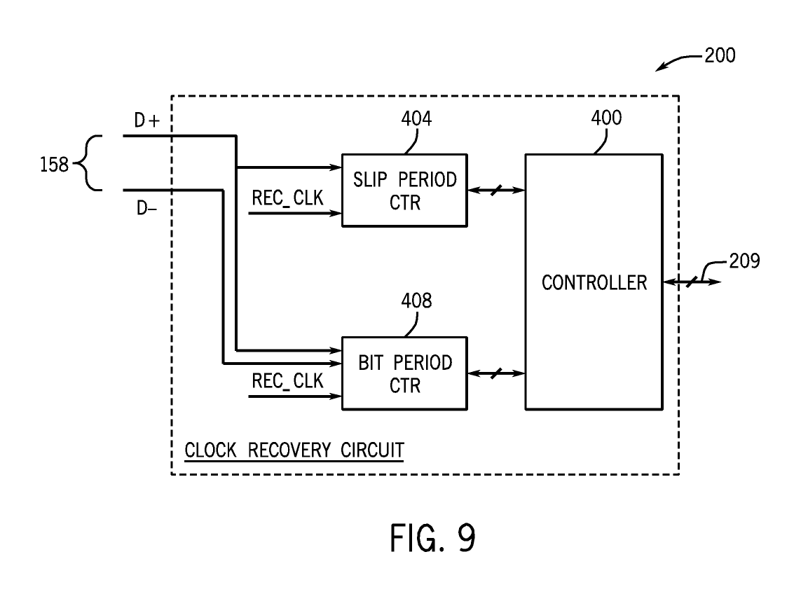

Referring to FIG. 9, in accordance with some embodiments of the invention, the clock recovery circuit 200 (see FIG. 3) of the clock system 98 may have an architecture similar to the one depicted in FIG. 9. Referring to FIG. 9 in conjunction with FIG. 3, in accordance with some embodiments of the invention, the DCO 210 of the clock system 98 is controlled by a controller 400 via control lines 209. As examples, the controller 400 may include a processor, may be hard-wired logic, may partially or entirely be implemented using the processor core 150, etc.

Regardless of the particular implementation of the controller 400, the controller 400 receives information from counters for purposes of locking the DCO 210 onto the clock signal embedded in data transitions on the USB 40. More specifically, in accordance with some embodiments of the invention, these counters include a bit period counter 408, which is clocked by the REC_CLK reference clock signal (generated by DCO 210) that generally has a frequency that is a specific multiple, termed N, of the frequency of the clock signal on the USB 40 when locked, in accordance with some embodiments of the invention. The bit period counter 408 allows the measurement of an interval (in terms of a number of clock cycles of the DCO 210) between adjacent data logic level transitions on the USB 40. When locked, this number of clock cycles should be an integer multiple of N. A phase slip is indicated when this number of cycles is not an integer multiple of N. The counters also include a slip period counter 404, which is also clocked by the REC_CLK reference clock signal, in accordance with some embodiments of the invention. The slip period counter 404 measures (in terms of a number of clock cycles of the DCO 210) a time between adjacent phase slips, as indicated by the bit period counter 408. Based on this information, the controller 400 adjusts the control signals that are provided to the DCO 210 for purposes of locking the DCO 210 onto the USB clock signal.

It is noted that the architecture depicted in FIG. 9 is one out of many possible architectures for a circuit that recovers a clock signal from the USB 40. Thus, many variations are contemplated and are within the scope of the appended claims. For the architecture that is depicted in FIG. 9, the architecture may incorporate features that are as further disclosed in U.S. Pat. No. 6,917,658, entitled, “CLOCK RECOVERY METHOD FOR BURSTY COMMUNICATIONS,” which granted on Jul. 12, 2005, and is hereby incorporated by reference in its entirety.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
recovering a first clock signal from data communication occurring over a bus;
providing the first clock signal as a reference for a frequency locked loop; and
operating the frequency locked loop to generate a second clock signal and furnish the second clock signal to a processor to clock operations of the processor.

2. The method of claim 1, wherein the operating the frequency locked loop comprises selecting a frequency of the second clock signal to clock operations of the processor in one of a first range that extends below the frequency of the first clock signal and a second range that extends above the frequency of the first clock signal.

3. The method of claim 1, wherein the recovering comprises recovering the first clock signal from a serial bus.

4. The method of claim 1, wherein the recovering comprises recovering the first clock signal from data communication that occurs in bursts with substantially no data communicated between the bursts.

5. The method of claim 1, the method further comprising controlling the frequency locked loop to adjust the second clock signal to selectively reduce interference in a radio circuit coupled to the processor.

6. The method of claim 1, the method further comprising controlling the frequency locked loop to selectively change the frequency of the second clock signal when a radio coupled to the processor is transmitting or receiving.

7. The method of claim 1, the method further comprising controlling the frequency locked loop to track frequency hopping by a radio coupled to the processor.

8. An apparatus comprising:
a processor to receive a system clock signal to clock operations of the processor;
a clock recovery circuit to recover a clock signal from data communication that occurs over a bus; and
a frequency locked loop to receive the recovered clock signal from the clock recovery circuit as a reference clock signal, the frequency locked loop being adapted to lock onto the recovered clock signal provided by the clock recovery circuit to provide the system clock signal.

9. The apparatus of claim 8, wherein the processor is adapted to control the frequency locked loop to select a frequency of the system clock signal in one of a first range that extends below the frequency of the recovered clock signal and a second range that extends above the frequency of the recovered clock signal.

10. The apparatus of claim 8, wherein the clock recovery circuit is adapted to recover the clock signal from a serial bus.

11. The apparatus of claim 8, wherein the clock recovery circuit is adapted to recover the clock signal from a data communication path in which bursts of data are communicated with substantially no data in between the bursts.

12. The apparatus of claim 8, further comprising:
a radio, wherein the processor is adapted to control the frequency locked loop to selectively avoid interference in radio bands used by the radio.

13. The apparatus of claim 8, further comprising:
a radio, wherein the processor is adapted to control the frequency locked loop to selectively change the frequency of the system clock signal when the radio is transmitting or receiving.

14. The apparatus of claim 8, further comprising:
a radio, wherein the processor is adapted to control the frequency locked loop to track frequency hopping by the radio.

15. An apparatus comprising:
an integrated circuit comprising a processor and a clock subsystem to furnish a system clock signal to clock operations of the processor,
wherein the clock subsystem comprises:
a clock recovery circuit adapted to recover a clock signal from data communication that occurs over a bus, and
a frequency locked loop to lock onto the recovered clock signal to provide the system clock signal.

16. The apparatus of claim 15, wherein the clock recovery circuit is adapted to recover the recovered clock signal from a data communication path in which bursts of data are communicated with substantially no data in between the bursts.

17. The apparatus of claim 15, wherein the processor is adapted to control the frequency locked loop to select a frequency of the system clock signal in one of a first range that extends below the frequency of the recovered clock signal and a second range that extends above the frequency of the recovered clock signal.

18. The apparatus of claim 15, wherein the clock recovery circuit is adapted to recover the clock signal from a serial bus.

19. The apparatus of claim 15, wherein the microcontroller couples to a radio, and wherein the processor is adapted to control the frequency of the frequency locked loop to selectively move interference out of radio bands used by the radio.

20. The apparatus of claim 15, wherein the microcontroller couples to a radio, and wherein the processor is adapted to control the frequency locked loop to selectively change the frequency of the system clock signal when the radio is transmitting or receiving.
